(19) United States
(12) Patent Application Publication
(10) Pub. No.: US 2024/0294559 A1
(43) Pub. Date: Sep. 5, 2024

(54) ONE POT PROCESS FOR PREPARATION OF A CHIRAL AMINO ACID

(71) Applicant: UPL LIMITED, Mumbai (IN)

(72) Inventors: Chandrasekhar Dayal MUDALIAR, Mumbai (IN); Ashishkumar Ravindra MISHRA, Mumbai (IN); Mukesh DESHMUKH, Mumbai (IN); Prashant Vasant KINI, Mumbai (IN)

(21) Appl. No.: 18/570,251

(22) PCT Filed: Jun. 15, 2022
(86) PCT No.: PCT/IB22/55521

§ 371 Date: Dec. 14, 2023

(30) Foreign Application Priority Data
Jun. 15, 2021 (IN) 202121026671

(51) Int. Cl. C07F 9/30

(52) U.S. Cl. CPC C07F 9/301

(57) ABSTRACT

The present invention discloses a synthesis of herbicidally active amino acid compounds. The present invention provides a simple and efficient process for preparation of L-glufosinate and its salts.

### FIELD OF THE INVENTION

The present invention relates to synthesis of herbicidally active amino acid compounds. Particularly the present invention provides a process for preparation of L-glufosinate and its salts.

### BACKGROUND OF THE INVENTION

DL-homoalanin-4-yl(methyl)phosphinic acid (glufosinate) and salts are amino acid derivatives with herbicidal activity. The amino acid derivatives are active in the L-form. Considering the relevance and advantages of using pure L-form for the herbicidal use, several processes have been developed to prepare L-homoalanin-4-yl(methyl)phosphinic acid (L-glufosinate).

U.S. Pat. No. 5,442,088 discloses preparation of L-glufosinate starting from L-homoserine lactone. The patent discloses the preparation of intermediate ethyl (2S)-2-[(methoxy carbonyl)amino]-4-[ethoxy(methyl)phosphoryl] butanoate by reacting ethyl (2S)-4-chloro-2-[(ethoxy carbonyl)amino] butanoate with large excess of diethyl methyl phosphonite.

CN106083922 discloses preparation of L-glufosinate starting from L-methionine. The patent discloses the preparation of intermediate ethyl (2S)-2-[(methoxy carbonyl)amino]-4-[ethoxy(methyl)phosphoryl] butanoate by reacting ethyl (2S)-4-chloro-2-[(ethoxy carbonyl)amino] butanoate with diethyl methyl phosphonite in presence of a catalyst.

CN109912649 discloses process for preparation of ethyl (2S)-2-[(methoxy carbonyl)amino]-4-[ethoxy(methyl)phosphoryl] butanoate by reacting ethyl (2S)-4-chloro-2-[(ethoxy carbonyl)amino] butanoate with diethyl methyl phosphonite in presence of a catalyst.

Inventors of the present invention noted that when the process is carried out using large excess of diethyl methyl phosphonite, it requires isolation and recycling of diethyl methyl phosphonite and in case a catalyst is used, it leads to the formation of a complex mixtures from which the isolation of the desired product is challenging.

There exists a need to develop an alternative, simple, cost-effective, reproducible, commercially viable and an efficient process for preparation of a chiral amino acid compounds with high yield, the process is simple, environmentally friendly and suitable for industrial production.

### OBJECT OF THE INVENTION

One of the objects of the present invention is to provide a convenient process for the synthesis of L-glufosinate or its salts.

Another object of the invention is to provide a cost effective one pot process for the synthesis of L-glufosinate or its salts.

### SUMMARY OF THE INVENTION

In an aspect the present invention provides a process for synthesis of L-glufosinate or salts thereof comprising the steps of;
a) reacting compound of Formula I with a compound of Formula II to get a compound of Formula III; and
b) converting compound of Formula III to L-glufosinate or salts by acid-base treatment.

In an aspect the process for synthesis L-glufosinate or salts thereof is performed according to following scheme 1.

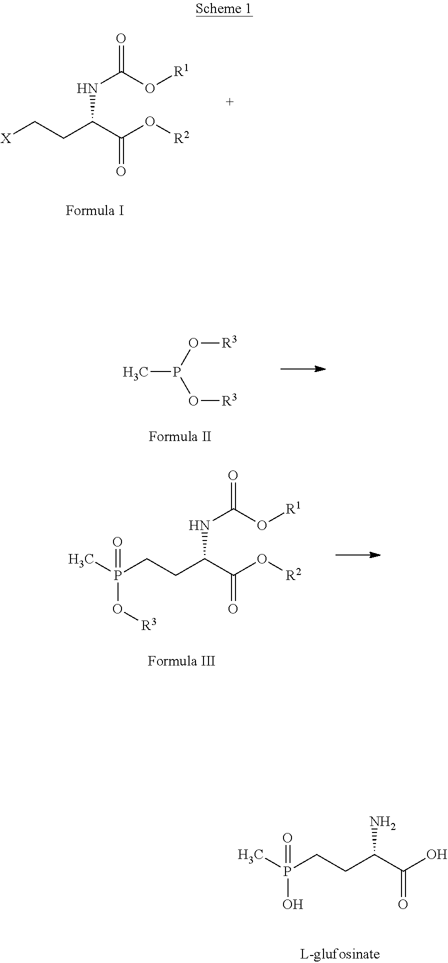

wherein X is a halogen, R₁, R₂ and R₃ are independently substituted or unsubstituted alkyl group having 1 to 6 carbon atoms, substituted or unsubstituted alkenyl group having 1 to 6 carbon atoms, or substituted or unsubstituted alkynyl group having 1 to 6 carbon atoms.

In another aspect the present invention provides a one pot process for synthesis of L-glufosinate or salts thereof comprising:
a) reacting compound of Formula I with a compound of Formula II to get a compound of Formula III; and
b) converting the compound of Formula III to L-glufosinate or salts by acid-base treatment
wherein in step a) a by-product of Formula R₃—X formed is simultaneously removed,
wherein R₃ is a substituted or unsubstituted alkyl group having 1 to 6 carbon atoms, substituted or unsubstituted alkenyl group having 1 to 6 carbon atoms, or substituted or unsubstituted alkynyl group having 1 to 6 carbon atoms.

In another aspect the present invention provides a process for synthesis of a compound of Formula III comprising reacting compound of Formula I with a compound of Formula II wherein a by-product of Formula R₃—X, is simultaneously removed to avoid the formation of a compound of Formula IV, wherein X is a halogen and, R₃ is independently substituted or unsubstituted alkyl group having 1 to 6 carbon atoms, substituted or unsubstituted alkenyl group having 1 to 6 carbon atoms, or substituted or unsubstituted alkynyl group having 1 to 6 carbon atoms.

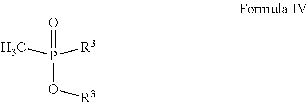

In another aspect the present invention provides an agrochemical composition comprising L-Glufosinate or its salts prepared according to the present process as described herein.

In yet another embodiment the present invention provides a method of controlling weeds with a composition comprising L-Glufosinate or its salts prepared according to the present process.

### DETAILED DESCRIPTION OF INVENTION

For convenience, before providing further description of the present invention, certain terms employed in the specification, examples are described here. These definitions should be read in light of the remainder of the disclosure and understood as by a person of skill in the art. Unless defined otherwise, all technical and scientific terms used herein have the same meaning as commonly understood by a person of ordinary skill in the art. The terms used throughout this specification are defined as follows, unless otherwise limited in specific instances.

The terms used herein are defined as follows.

As used in the specification and the claims, the singular forms “a”, “an”, and “the” include plural referents unless the context clearly dictates otherwise.

The present disclosure is not to be limited in scope by the specific embodiments described herein, which are intended for the purposes of exemplification only.

The term “room temperature” unless stated otherwise, essentially means temperature in range of about 20-45° C.

The term “purity” means purity as determined by HPLC (“High Pressure Liquid Chromatography”).

The term “about” shall be interpreted to mean “approximately” or “reasonably close to” and any statistically insignificant variations therefrom. As used herein, the term “about” refers to a measurable value such as a parameter, an amount, a temporal duration, and the like and is meant to include variations of +/−15% or less, specifically variations of +/−10% or less, more specifically variations of +/−5% or less, even more specifically variations of +/−1% or less, and still more specifically variations of +/−0.1% or less of and from the particularly recited value, in so far as such variations are appropriate to perform in the disclosure described herein.

Furthermore, it is also to be understood that the value to which the modifier “about” refers is itself specifically disclosed herein.

As used herein, the terms “comprising” “including,” “having,” “containing,” “involving,” and the like are to be understood to be open-ended, i.e., to mean including but not limited to.

The terms “preferred” and “preferably” refer to embodiments of the invention that may afford certain benefits, under certain circumstances. In an embodiment, the aspects and embodiments described herein shall also be interpreted to replace the clause “comprising” with either “consisting of” or with “consisting essentially of” or with “consisting substantially of”.

The term “substantially free” as used herein refers to active ingredient 10% or less, 5% or less, 2% or less, or 1% or less of compound of formula IV.

As used herein, the term “alkyl” As used herein, the term “alkyl” whether used alone or as part of a substituent group, refers to the radical of saturated aliphatic groups, including straight or branched-chain alkyl groups. An alkyl group can have a straight chain or branched chain containing 1 to 12 carbon atoms. Alkyl groups include methyl, ethyl, n-propyl, isopropyl, n-butyl, t-butyl, iso-butyl, sec-butyl, n-pentyl, isopentyl, 2-pentyl, 3-pentyl, neo-pentyl, n-hexyl, isohexyl, 2-hexyl, 3-hexyl, n-heptyl, n-octyl, n-nonyl and n-decyl.

As used herein, the term “alkynyl” whether used alone or as part of a substituent group, refers to a straight or branched chain hydrocarbon radical containing the indicated number of carbon atoms and at least one carbon-carbon triple bond (two adjacent sp carbon atoms). For example, (C₂-C₁₂)-alkynyl refers to an alkynyl group having 2-12 carbon atoms. Examples of alkynyl include, but are not limited to, ethynyl, 1-propynyl, 3-propynyl and 3-butynyl.

As used herein, the term “alkenyl” whether used alone or as part of a substituent group, refers to a straight or branched chain hydrocarbon radical containing the indicated number of carbon atoms and at least one carbon-carbon double bond (two adjacent sp2 carbon atoms). For example, (C₂-C₁₂)-alkenyl refers to an alkenyl group having 2 to 6 carbon atoms. Depending on the placement of double bond and substituents if any, the geometry of the double bond may be (E) isomer, or (Z) isomer, cis or trans. Examples of alkenyl include, but are not limited to, vinyl, allyl and 2-propenyl.

The term “halogen” refers to a fluorine, chlorine, bromine, or iodine atom.

As used herein, the term “L-glufosinate” includes the L-isomer of Glufosinate, a salt and an ester thereof. The L-isomer of glufosinate is a structural analogue of glutamate and, therefore, is a competitive inhibitor of the enzyme glutamine synthetase (GS) of bacteria and plants. The L-enantiomer of glufosinate acts by inhibition of glutamine synthetase thereby causing accumulation of toxic levels of ammonium ion and indirectly stopping photosynthesis. It is also known as phosphinothricin or (S)-2-amino-4-(hydroxy(methyl)phosphonoyl)butanoic acid. The term can generically refer to any form of L-glufosinate such as solvates, hydrates, esters, anhydrous form, polymorph forms, pseudo polymorph forms, amorphous form or mixture thereof, and sodium, potassium or ammonium salts. The salts of L-glufosinate such as monosodium salt, disodium salt, monopotassium salt, dipotassium salt, calcium salt, ammonium salt, —NH₃(CH₃)⁺ salt, —NH₂(CH₃)²⁺ salt, —NH(CH₃)³⁺ salt, —NH(CH₃)₂(C₂H₄OH)⁺ salt, and —NH₂(CH₃)(C₂H₄OH)⁺ salt are included in the definition. The agronomically acceptable salts include L-glufosinate-ammonium, L-glufosinate-sodium, and L-glufosinate-potassium. The term may also refer to an isomeric (racemic) mixture of L-glufosinate, D-glufosinate and salts thereof, wherein the content of L-glufosinate in the mixture is 70% or greater, preferably 80% or greater and more preferably 90% or greater. Typically, the ratio of L-glufosinate:D-glufosinate can be in the range from about 90:10 to about 99.9:0.1, preferably from about 95:5 to about 99.9:0.1.

It is an object of the present invention to develop a process for preparation of a chiral amino acid compounds. A highly effective process for the preparation of L-glufosinate has been developed by the present inventors wherein the synthesis of an intermediate involves the simultaneous removal of a by-product from the reaction mixture. The in-situ removal of the by-product eliminates the chances of side reaction of the by-product with the substrate. This leads to an efficient conversion of the substrate to the product without the requirement of higher molar ratio of the reactants. Further, this process will avoid the use of a catalyst which may lead to the formation of complex reaction mixture. Further purification steps of the intermediate compound obtained from the complex reaction mixture may also be avoided. It has been further noted that the process can be performed in a one pot as the isolation of intermediate compounds is avoided.

Accordingly, the present invention provides a process for synthesis of L-glufosinate or salts thereof in one pot synthesis comprising:
a) reacting a compound of Formula I with a compound of Formula II to get a compound of Formula III; and
b) converting compound of Formula III to L-glufosinate or salts.

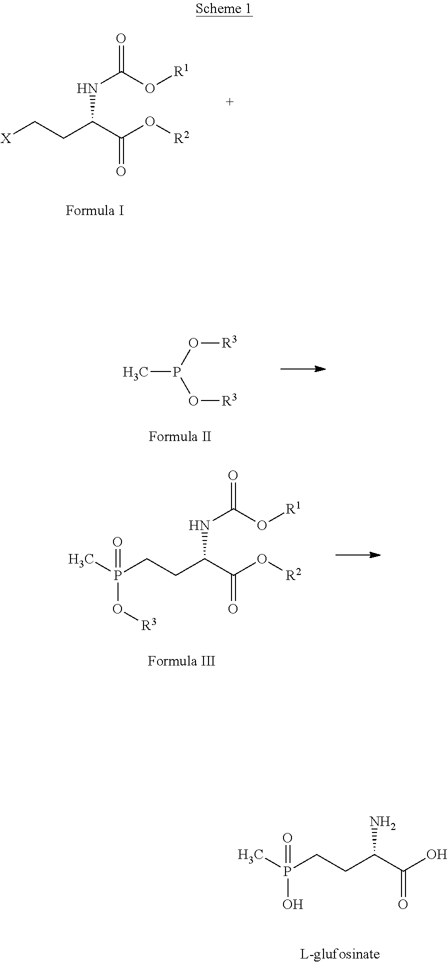

wherein X is a halogen and R₁, R₂ and R₃ are independently substituted or unsubstituted alkyl group having 1 to 6 carbon atoms, substituted or unsubstituted alkenyl group having 1 to 6 carbon atoms, or substituted or unsubstituted alkynyl group having 1 to 6 carbon atoms.

In an embodiment a by-product formed in the step a) is simultaneously removed thereby making the process a one pot process.

In an embodiment the preferred compound of Formula I is wherein X=chlorine and R₁ and R₂=methyl.

In an embodiment the preferred compound of Formula II is wherein R₃=ethyl.

In an embodiment the preferred compound of Formula III is wherein R₁ and R₂=methyl and R₃=ethyl.

In an embodiment the preferred L-glufosinate salt is L-glufosinate ammonium.

In an embodiment the step a) of reacting compound of Formula I with a compound of Formula II is carried out in the absence of a solvent.

In an embodiment the step a) of reacting compound of Formula I with a compound of Formula II is carried out in the absence of a catalyst.

In an embodiment the step a) of reacting compound of Formula I with a compound of Formula II is carried out at temperature from about 100-150° C.

In an embodiment the step of reacting compound of Formula I with a compound of Formula II is carried out at temperature from about 100-150° C. for 10 to 20 hours.

In an embodiment the gaseous by-products of the reaction in step a) of the process are simultaneously and continuously removed.

In an embodiment the continuous removal of the gaseous by-products of reaction is performed by displacement with an inert gas or by applying vacuum.

In an embodiment the gaseous by-products of reaction are displaced by nitrogen gas.

In an embodiment the excess of compound of Formula II is removed by distillation.

In an embodiment the step b) of converting compound of Formula III to L-glufosinate or salts is performed without the isolation of compound of Formula III in the step a).

In an embodiment the step b) of converting the compound of Formula III to L-glufosinate or salts is carried out by acid-base treatment.

In an embodiment the acid treatment in step b) is performed by using an inorganic acid for example hydrochloric acid or sulfuric acid.

In an embodiment the step b) is performed by treating compound of Formula III with an inorganic acid till the corresponding acid addition salt is formed followed by treatment with a base.

In an embodiment the step b) is performed by heating the compound of Formula III with an inorganic acid till the corresponding acid addition salt is formed followed by treatment with a base.

In a preferred embodiment the acid addition salt is L-glufosinate hydrochloride salt.

In an embodiment the base treatment in step b) to obtain L-glufosinate salt is performed by using a base for example alkali, alkaline earth metal salts or hydroxides or ammonia.

The L-glufosinate salt is selected from monosodium salt, disodium salt, monopotassium salt, dipotassium salt, calcium salt, ammonium salt, —NH₃(CH₃)+ salt, —NH₂(CH3)2+ salt, —NH(CH₃)₃+salt, —NH(CH₃)2(C2H4OH)+ salt, and —NH2(CH3)(C2H4OH)+ salt of L-glufosinate.

In a preferred embodiment acid-base treatment in the step b) comprises the following steps;
i) treating a compound of formula III with an acid to form an acid addition salt;
ii) adding an alcohol solvent to obtain a mixture;
iii) contacting the mixture with a base to obtain L-glufosinate or its salts.

In an embodiment the present process is a one pot process to obtain L-glufosonate or its salts without the isolation of the compound of formula III or the corresponding acid addition salts.

In an embodiment the acid used in step i) is an inorganic acid for example hydrochloric acid or sulfuric acid.

In an embodiment the acid used is hydrochloric acid.

In a preferred embodiment the alcohol solvent is methanol.

In a preferred embodiment the base treatment in step iii) is performed in non-aqueous conditions.

In an embodiment the base used is selected from group of alkali, alkaline earth metal salts or hydroxides or ammonia or gaseous ammonia.

In an embodiment the base used is ammonia.

In a preferred embodiment the base is gaseous ammonia.

In a preferred embodiment the step ii) is carried out by maintaining pH of the mixture in the range from 2.5 to 4 to produce L-glufosinate.

In a preferred embodiment the step ii) is carried out by maintaining pH of the mixture in the range from 7 to 9 to produce L-glufosinate salt.

In a preferred embodiment the step ii) is carried out by maintaining pH of the mixture in the range from 7 to 9 to produce L-glufosinate ammonium.

In an embodiment, the base treatment further comprises maintaining the reaction mixture at temperature ranging from 20 to 80° C. for a period ranging from 1 to 8 hours.

In another embodiment the present invention provides a process for synthesis of L-glufosinate or salts thereof in one pot synthesis comprising
a) reacting a compound of Formula I with a compound of Formula II to get a compound of Formula III; and
b) converting the compound of Formula III to L-glufosinate or its salt.

In an embodiment the process comprises subjecting the compound of formula III to acid-base treatment without isolation from step a) and a by-product of Formula R₃—X formed during the reaction in step a) is simultaneously removed. In the present invention the process for synthesis of L-glufosinate or its salts is a one pot process/synthesis. In an embodiment the by-product is a compound formula R₃—X, X is halogen and R₃ is a substituted or unsubstituted alkyl group having 1 to 6 carbon atoms, substituted or unsubstituted alkenyl group having 1 to 6 carbon atoms, or substituted or unsubstituted alkynyl group having 1 to 6 carbon atoms.

In an embodiment, the by-product of formula R₃—X formed during the reaction in the step a) is simultaneously removed.

In a preferred embodiment the compound of Formula R₃—X is a alkyl halide.

In an embodiment the compound of Formula R₃—X is a C₁-C₆ alkyl halide.

In an embodiment the compound of Formula I is having X=chlorine and R₁ and R₂=methyl.

In a preferred embodiment the compound of Formula I is ethyl (2S)-4-chloro-2-[(ethoxy carbonyl)amino] butanoate.

In an embodiment the compound of Formula II is having R₃=ethyl.

In a preferred embodiment the compound of Formula II is diethyl methyl phosphonite.

In a preferred embodiment, compound of Formula III is ethyl (2S)-2-[(methoxy carbonyl)amino]-4-[ethoxy(methyl)phosphoryl] butanoate.

In a preferred embodiment L-glufosinate salt is L-glufosinate ammonium.

In an embodiment, the process for preparation of L-glufosinate or its salt proceeds with the compound of Formula III.

In an embodiment, the process for preparation of L-glufosinate or its salt proceed by ethyl (2S)-2-[(methoxy carbonyl)amino]-4-[ethoxy(methyl)phosphoryl] butanoate.

In an embodiment there is provided a process for synthesis of L-glufosinate ammonium comprising:
reacting ethyl (2S)-4-chloro-2-[(ethoxy carbonyl)amino] butanoate with diethyl methyl phosphonite to get ethyl (2S)-2-[(methoxy carbonyl)amino]-4-[ethoxy(methyl)phosphoryl] butanoate; and subjecting ethyl (2S)-2-[(methoxycarbonyl)amino]-4-[ethoxy(methyl)phosphoryl] butanoate to acid base treatment to obtain L-glufosiante ammonium.

In an embodiment there is provided a process for synthesis of L-glufosinate ammonium comprising the steps of:
a) reacting ethyl (2S)-4-chloro-2-[(ethoxy carbonyl)amino] butanoate with diethyl methyl phosphonite to get ethyl (2S)-2-[(methoxy carbonyl)amino]-4-[ethoxy(methyl)phosphoryl] butanoate; and converting ethyl (2S)-2-[(methoxycarbonyl)amino]-4-[ethoxy(methyl)phosphoryl] butanoate to L-glufosiante ammonium.

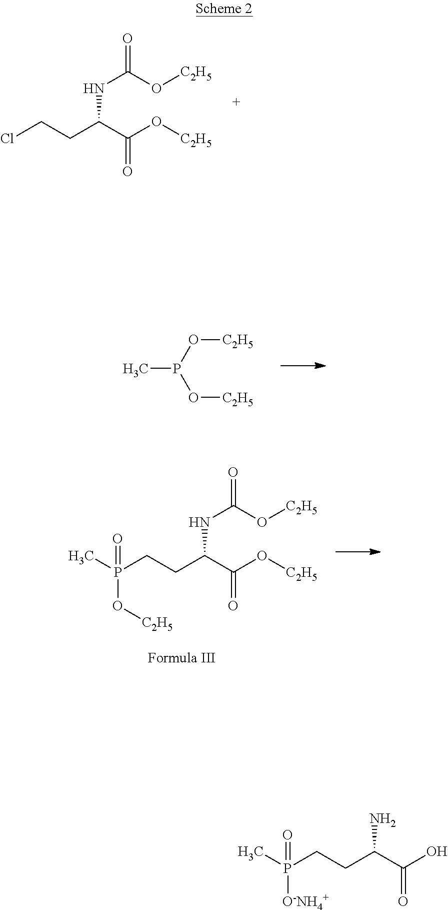

In a preferred embodiment the process is represented in the scheme 2. In an embodiment, the compound of formula III is subjected to acid-base treatment wherein in step a), ethyl chloride is a by-product continuously removed to realize a one pot synthesis.

The invention further provides a process for synthesis of a compound of Formula III comprising reacting a compound of Formula I with a compound of Formula II wherein a by-product of Formula R₃—X is continuously removed to avoid the formation of a compound of Formula IV, wherein X is a halogen, R₁, R₂ and R₃ are independently substituted or unsubstituted alkyl group having 1 to 6 carbon atoms, substituted or unsubstituted alkenyl group having 1 to 6 carbon atoms, or substituted or unsubstituted alkynyl group having 1 to 6 carbon atoms.

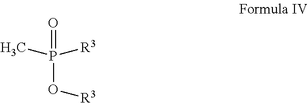

In a preferred embodiment the compound of Formula R₃—X is an alkyl halide.

In the general reaction conditions for preparation of compound of Formula III, the compound of Formula R₃—X can react with compound of Formula II to form compound of Formula IV, which results in excess consumption of compound of Formula II. Further it requires additional procedures for separating this compound from the required product of Formula III.

In an embodiment the compound of formula III obtained is substantially free from a compound of Formula IV.

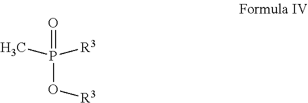

wherein R₃ is substituted or unsubstituted alkyl group having 1 to 6 carbon atoms, substituted or unsubstituted alkenyl group having 1 to 6 carbon atoms, or substituted or unsubstituted alkynyl group having 1 to 6 carbon atoms.

In a present invention the process for preparation of (2S)-2-[(methoxy carbonyl)amino]-4-[ethoxy(methyl)phosphoryl] butanoate as represented in scheme 3 comprising reacting ethyl (2S)-4-chloro-2-[(ethoxy carbonyl)amino] butanoate with diethyl methyl phosphonite, wherein the by-product ethyl chloride is continuously removed to avoid the formation of ethyl ethylmethyl phosphonite as represented in Scheme 4.

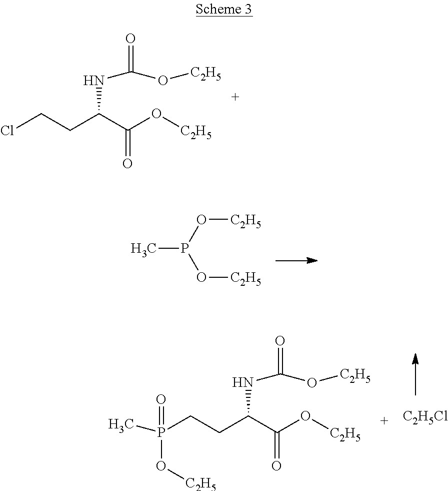

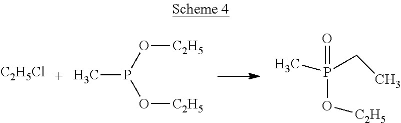

In an embodiment, according to the present process L-glufosinate or its salt obtained is substantially free from a compound of Formula IV.

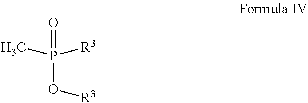

wherein R₃ is substituted or unsubstituted alkyl group having 1 to 6 carbon atoms, substituted or unsubstituted alkenyl group having 1 to 6 carbon atoms, or substituted or unsubstituted alkynyl group having 1 to 6 carbon atoms.

In another embodiment there is provided use of L-glufosinate or its salts prepared according to the present process for the preparation of agrochemical composition or formulation.

In another embodiment there is provided use of L-glufosinate or its salts prepared using the compound of formula III in one pot synthesis for the preparation of agrochemical composition or formulation.

In an embodiment, the agrochemical composition comprising L-glufosinate or its salts prepared according to the present process as described herein.

According to another embodiment, the present invention provides a herbicidal composition comprising L-glufosinate or its salts prepared according to the process as described herein and an agrochemically acceptable excipients.

In an embodiment the agrochemical composition comprising L-glufosinate or L-glufosinate ammonium prepared according to the present invention from 1 to 99% by weight of the total composition and an agrochemically acceptable excipient from about 1 to 50% by weight of the total composition.

In an embodiment, the agronomically acceptable excipients can be selected from, but not limited to, surfactants, solvent, fertilizer, pH modifiers, crystallization inhibitors, viscosity modifiers, suspending agents, spray droplet modifiers, pigments, antioxidants, foaming agents, light-blocking agents, compatibilizing agents, antifoam agents, sequestering agents, neutralizing agents, corrosion inhibitors, dyes, odorants, spreading agents, penetration aids, micronutrients, emollients, lubricants, sticking agents, dispersing agents, thickening agents, freezing point depressants, antimicrobial agents, and the like.

According to an embodiment of present invention, the dispersion comprising single isomer of glufosinate salt and at least one organic solvent may further comprise a surfactant.

The surfactants used in the process may be selected from anionic, cationic or zwitterionic and/or non-ionic surface-active compounds (surfactants) or combinations thereof.

Examples of anionic surfactants include: anionic derivatives of fatty alcohols having 10-24 carbon atoms in the form of ether carboxylates, sulfonates, sulfates, and phosphates, and their inorganic salts (e.g., alkali metal and alkaline earth metal salts) and organic salts (e.g., salts based on amine or alkanolamine); anionic derivatives of copolymers consisting of EO (ethylene oxide), PO (propylene oxide) and/or BO (butylene oxide) units, in the form of ether carboxylates, sulfonates, sulfates, and phosphates, and their inorganic salts (e.g., alkali metal and alkaline earth metal salts) and organic salts (e.g., salts based on amine or alkanolamine); derivatives of alkylene oxide adducts of alcohols, in the form of ether carboxylates, sulfonates, sulfates and phosphates, and their inorganic salts (e.g., alkali metal and alkaline earth metal salts) and organic salts (e.g., salts based on amine or alkanolamine); derivatives of fatty acid alkoxylates, in the form of ether carboxylates, sulfonates, sulfates and phosphates, and their inorganic salts (e.g., alkali metal and alkaline earth metal salts) and organic salts (e.g., salts based on amine or alkanolamine); alkyl ether phosphate, sulfosuccinate & its derivatives, sulfosuccinate half ester, alkyl sulfosuccinate mono ester and diester salts.

Examples of cationic or zwitterionic surfactants may be selected from alkylene oxide adducts of fatty amines, quaternary ammonium compounds having 8 to 22 carbon atoms (C₈-C₂₂), surface-active zwitterionic compounds such as taurides, betaines and sulfobetaines.

Examples of non-ionic surfactants are: alkylpolyglycosides, alkyl glucamide, alkyl amine oxides having C₈ to C₂₀ carbon atoms, alcohol ethoxylate, fatty acid methyl ester, sorbitan ester and ethoxylated sorbitan ester, ethoxylated alkylphenol, ethoxylated tristyrylphenol and alkyl amide, fatty alcohols having 10-24 carbon atoms with 0-60 ethylene oxide (EO) and/or 0-20 propylene oxide (PO) and/or 0-15 butylene oxide (BO) in any order; fatty acid alkoxylates and triglyceride alkoxylates; fatty acid amide alkoxylates; alkylene oxide adducts of alkynediols; sugar derivatives such as amino sugars and amido sugars; polyacrylic and polymethacrylic derivatives; polyamides such as modified gelatins or derivatized polyaspartic acid; surfactant polyvinyl compounds such as modified PVP; polyol-based alkylene oxide adducts; polyglycerides and derivatives thereof.

In an aspect there is provided use of the present composition prepared according to the present invention to control harmful/undesired plants.

In an embodiment the present invention provides use of present composition comprising L-glufosinate or its salts prepared according to the present invention optionally with other auxiliary ingredients to control harmful/undesired plants/weeds.

The above mentioned compositions provide effective weed control to keep agricultural crops free from undesired competing plants and thus to safeguard and/or increase the yields.

In another embodiment the present invention provides a method of controlling undesired plants by applying the present compositions comprising L-glufosinate or L-glufosinate ammonium prepared according to the present invention.

In an embodiment, the composition of the present invention may be applied to the locus either simultaneously or sequentially, such that the herbicide may be applied in a tank mix or as a pre-mixed composition.

In an embodiment, the method comprises pre or post emergent application of present compositions.

The present method may be carried out by spraying the suggested tank mixes or may be formulated as a kit-of-parts containing various components that may be mixed as instructed prior to spraying.

According to an embodiment of the present invention, there is provided a kit comprising the present composition containing L-glufosinate or its salt prepared by present invention for controlling harmful plants/weeds.

The instant invention is more specifically explained by below examples. However, it should be understood that the scope of the present invention is not limited by the examples in any manner. It will be appreciated by any person skilled in this art that the present invention includes aforesaid examples and further can be modified and altered within the technical scope of the present invention.

### EXAMPLES

Methods: The qualitative analysis of L-isomer and D-isomer in L-glufosinate ammonium is performed using HPLC Column-Chirex 3126 (D)-penicillamine LC column (150×4.6 mm).

### Example 1: Preparation of L-glufosinate Ammonium

500 gm of ethyl (2S)-4-chloro-2-[(ethoxy carbonyl)amino] butanoate and 430 g (1.5 equiv.) of diethyl methylphosphonite were charged to a reaction flask at 25-30° C. The mixture was heated at 140° C. for 20 hours while flushing with nitrogen continuously in the system. After completion of the reaction, the excess diethyl methylphosphonite was distilled off under vacuum to get 650 gm of crude ethyl (2S)-2-[(ethoxy carbonyl)amino]-4-[ethoxy(methyl)phosphoryl] butanoate (ethyl ethylmethyl phosphonite: less than 0.5% by HPLC). 2.1 kg of conc. HCl (10 equiv.) was added to the flask and refluxed the mixture at 100° C. for 16 hrs. After the completion of the reaction, water was distilled off completely. Then 3.1 litre of methanol was added and purged with dry ammonia gas till pH 8-8.5. The reaction mixture was heated at 60° C. for 4 hrs. The reaction mixture was then cooled, the precipitate thus obtained was filtered and washed with 300 ml methanol and dried under vacuum at 50° C. to get 283 gm of L-glufosinate ammonium. % w/w purity more than 96%, L:D ratio—97:03, yield: 68%.

### Example 2: Preparation of L-glufosinate Ammonium

10.0 gm of ethyl (2S)-4-chloro-2-[(ethoxy carbonyl)amino] butanoate and 8.6 g (1.5 equiv.) of diethyl methylphosphonite were charged to a reaction flask at 25-30° C. The mixture was heated at 140° C. for 20 hours while flushing with nitrogen continuously in the system. After completion of the reaction, the excess diethyl methylphosphonite was distilled off under vacuum to get 13.0 gm of ethyl (2S)-2-[(ethoxy carbonyl)amino]-4-[ethoxy(methyl)phosphoryl] butanoate, (ethyl ethylmethyl phosphonite: <0.5% by HPLC). 42.0 gm of conc. HCl (10 equiv.) was added to the flask and refluxed the mixture for 16 hrs. After the completion of the reaction, water was distilled off completely. Then 62.0 ml of methanol was added and purged with dry ammonia gas till pH between 2.5 to 4. The reaction mixture was then stirred at 25° C. to 30° C. for 4 hrs. The solid thus obtained was filtered and washed with 6.0 ml of methanol and dried under vacuum at 50° C. to get 6.0 g L-glufosinate ammonium % w/w purity more than 96%, L:D ratio—97:03, yield: 72%.

### Example 3: Preparation of L-glufosinate Ammonium

10.0 gm of ethyl 4-chloro-2-[(methoxy carbonyl)amino] butanoate and 6.9 g (1.5 equiv.) of diethyl methylphosphonite were charged to a reaction flask at 25-30° C. The mixture was heated at 140° C. for 20 hours while flushing with Nitrogen continuously in the system. After completion of the reaction, the excess diethyl methylphosphonite was distilled off under vacuum to get 12 g of ethyl (2S)-2-[(methoxy carbonyl)amino]-4-[ethoxy(methyl)phosphoryl] butanoate (wherein ethyl ethylmethyl phosphonite (compound of formula (IV) is less than 0.5% by HPLC). 40.0 gm of conc. HCl (10 equiv.) was added to the flask and refluxed the mixture at 100 C for 16 hrs. After the completion of the reaction, water was distilled off completely. Then 62.0 ml of methanol was added and purged with dry ammonia gas till pH 8-8.5. The reaction mixture was heated at 60° C. for 4 hrs. The mixture was then cooled, the precipitate thus obtained was filtered and washed with 6 ml methanol and dried under vacuum at 50° C. to get 5.7 gm L-glufosinate ammonium (% w/w purity more than 96%, L:D ratio—97:03, % enantiomeric excess (ee)-94, yield: 68%).

### COMPARATIVE EXAMPLE

### Preparation of ethyl (2S)-2-[(ethoxy carbonyl)amino]-4-[ethoxy(methyl)phosphoryl] butanoate in the Absence of Continuous Flushing with Nitrogen

10.0 gm of ethyl (2S)-4-chloro-2-[(ethoxy carbonyl)amino] butanoate and 8.6 g (1.5 equiv.) of diethyl methylphosphonite were charged to a reaction flask at 25-30° C. The mixture was heated at 140° C. for 20 hours in nitrogen atmosphere. After completion of the reaction, the excess diethyl methylphosphonite was distilled off under vacuum to get 14.50 gm of ethyl (2S)-2-[(ethoxy carbonyl)amino]-4-[ethoxy(methyl)phosphoryl] butanoate (ethyl ethylmethyl phosphonite: 14% by HPLC).

1. A process for synthesis of L-glufosinate or salts thereof in one pot synthesis comprising steps of:
a) reacting a compound of Formula I with a compound of Formula II to get a compound of Formula III; and
b) converting the compound of Formula III to L-glufosinate or salts. 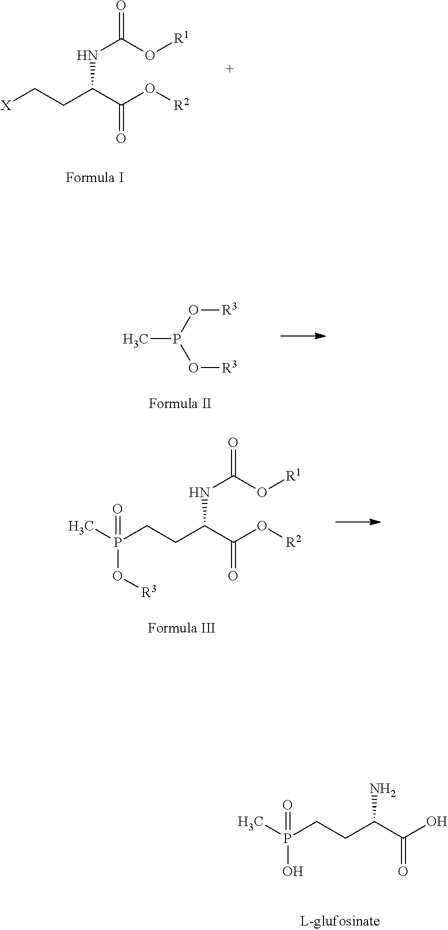
wherein X is a halogen and R₁, R₂ and R₃ are independently substituted or unsubstituted alkyl group having 1 to 6 carbon atoms, substituted or unsubstituted alkenyl group having 1 to 6 carbon atoms, or substituted or unsubstituted alkynyl group having 1 to 6 carbon atoms.

2. The process as claimed in claim 1 wherein a by-product of formula R₃—X formed during the reaction in the step a) is simultaneously removed.

3. The process as claimed in claim 1, wherein the compound of Formula I having X=chlorine and R₁ and R₂=methyl.

4. The process as claimed in claim 1 wherein said step b) of converting the compound of Formula III to L-glufosinate or its salts comprises subjecting the compound of Formula III to acid-base treatment.

5. The process as claimed in claim 1, wherein the compound of Formula II having R₃=ethyl.

6. The process as claimed in claim 1, wherein said L-glufosinate salt is L-glufosinate ammonium.

7. The process as claimed in claim 4, wherein the acid-base treatment comprises;
i) treating a compound of formula III with an inorganic acid to form an acid addition salt;
ii) adding an alcohol solvent to obtain a mixture;
iii) contacting the mixture with a base to obtain L-glufosinate or its salts.

8. The process as claimed in claim 7, wherein the alcohol solvent in step ii) is methanol.

9. The process as claimed in claim 7, wherein the step iii) is carried in non-aqueous conditions.

10. The process as claimed in claim 7, wherein the acid used is an inorganic acid.

11. The process as claimed in claim 7, wherein the base used is selected from group of alkali, alkaline earth metal salts or hydroxides or ammonia.

12. The process as claimed in claim 2, wherein said by-product is formula R₃—X, wherein R₃ is a substituted or unsubstituted alkyl group having 1 to 6 carbon atoms, substituted or unsubstituted alkenyl group having 1 to 6 carbon atoms, or substituted or unsubstituted alkynyl group having 1 to 6 carbon atoms.

13. The process as claimed in claim 12, wherein said compound of formula R₃—X is a C₁-C₆ alkyl halide.

14. The process as claimed in claim 1, wherein the compound of formula III obtained is substantially free from a compound of Formula IV. 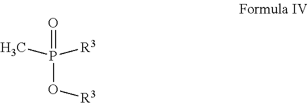
wherein R₃ is substituted or unsubstituted alkyl group having 1 to 6 carbon atoms, substituted or unsubstituted alkenyl group having 1 to 6 carbon atoms, or substituted or unsubstituted alkynyl group having 1 to 6 carbon atoms.

15. The process as claimed in claim 1 wherein the L-glufosinate or its salt obtained is substantially free from a compound of Formula IV. 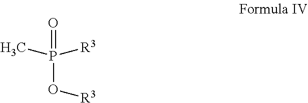
wherein R₃ is substituted or unsubstituted alkyl group having 1 to 6 carbon atoms, substituted or unsubstituted alkenyl group having 1 to 6 carbon atoms, or substituted or unsubstituted alkynyl group having 1 to 6 carbon atoms.
